(19) United States
(12) Patent Application Publication
(10) Pub. No.: US 2003/0074937 A1
(43) Pub. Date: Apr. 24, 2003

(54) Method for preventing unauthorized unlocking of a code unit of a device of a lock variety

(76) Inventor: David Isaakovich Shafirkin, Moscow (RU)

Correspondence Address: LADAS & PARRY, 224 SOUTH MICHIGAN AVENUE, SUITE 1200, CHICAGO, IL, 60604, US

(21) Appl. No.: 10/257,749

(22) PCT Filed: Apr. 6, 2001
(86) PCT No.: PCT/RU01/00136

(51) Int. Cl. E05B 15/16; E05B 63/00

(52) U.S. Cl. 70/333 R

(57) ABSTRACT

The method of unauthorized code units unblocking through certain manipulations based on listening to signals that appear when code elements contact with a locking rod. and that are easily picked by human ear is widely used in practice. The inventive method eliminates the possibility of unauthorized code unit unblocking by using such signals by providing locking rod movements blocked when the code lock pins or interim elements between code lock pins and the locking rod are unblocked, and allowing unblocked locking rod movements having the code lock pins or interim elements between code lock pins and the locking rod blocked. Locking type devices that have dials with discrete marking with symbols (for example digits) are widely used in practice. The symbols are used to set the dial to a working position. However it is possible to see a right combination and then the dial can be illicitly set to the detected working position. The inventive method allows eliminating such possibility through using discrete marking without any symbols. The dial is set to the working position through counting a predetermined number of the deal marks after a signal which arises while turning the dial and which is perceived by tactile organs only.

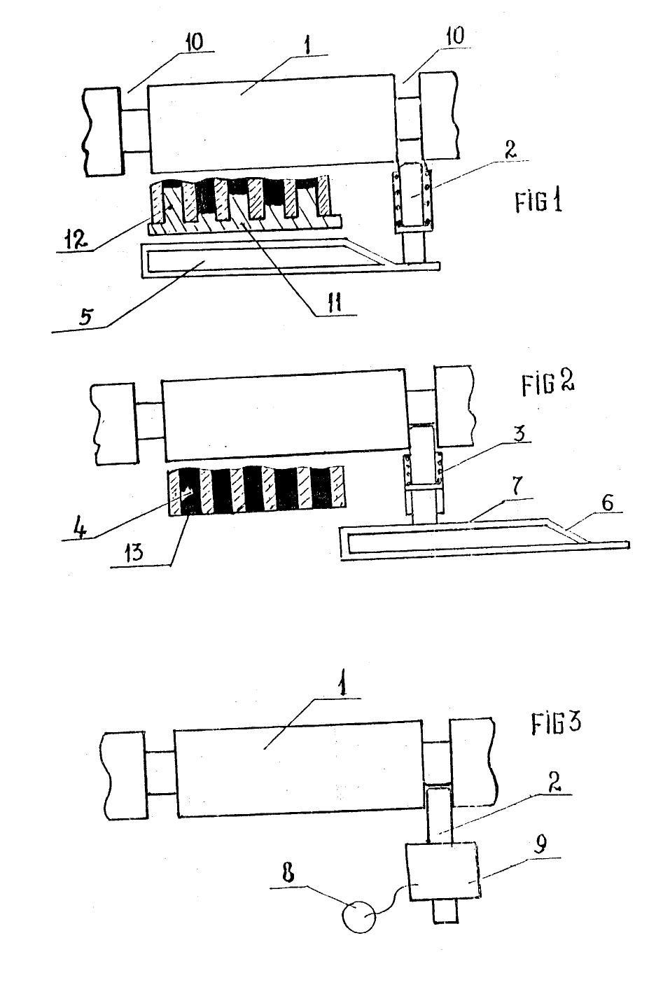

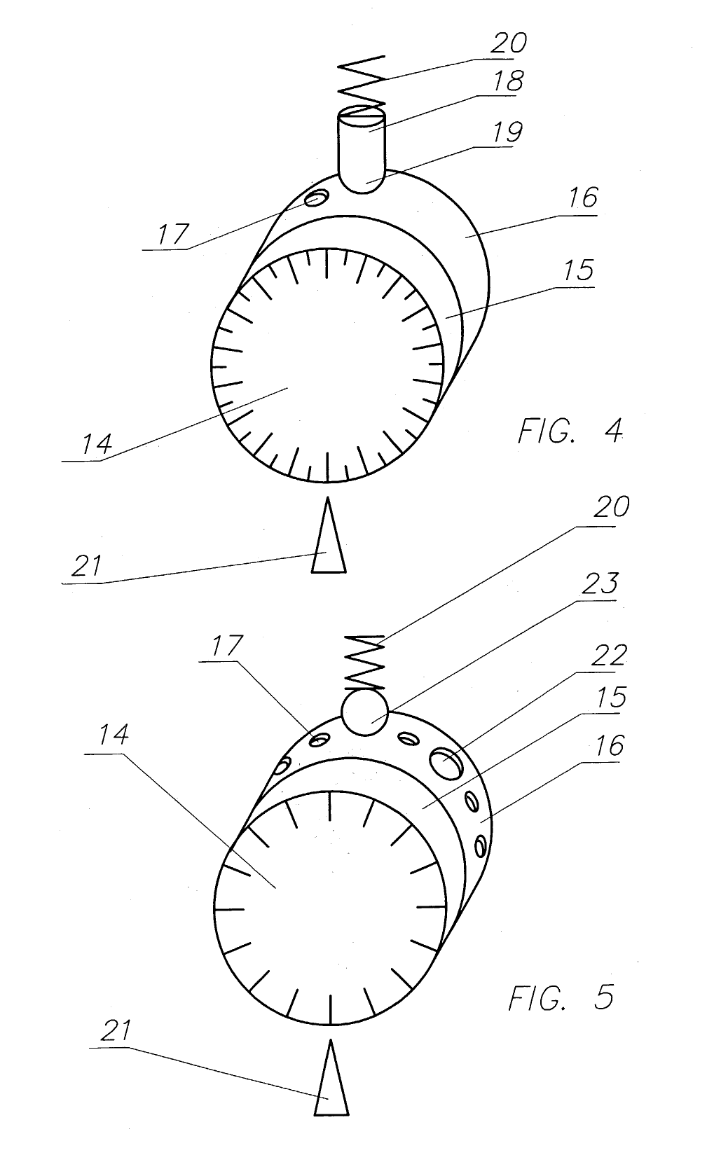

This invention relates to locking devices and is intended to prevent unauthorized code unit unblocking of locking type device.

Code device of the locking type has usually two main elements in its construction that interact with each other, i.e. coded and coding elements called locking rod and lock pin correspondingly.

The U.S. Pat. No. 5,024,071 of Jun. 18, 1996 was granted for code unit containing a case in which code lock pins were placed in certain holes. These lock pins have both working and false hollows. Apart from the case the device has locking rod with radial stops, cross-section of which corresponds to profile of code lock pin hollows interacting with locking rod. However, this device could easily suffer unauthorized unblocking in the following way. All you need is to find out working hollows of code lock pins by using signals that appear during enumeration of positions of code lock pins relatively to locking rod. Locking rod can move within the existing backlash and sounds that appear during this movement can easily be heard.

There is a well-known method to prevent unauthorized unblocking of the locking type device (see patent RU 2135719 MIIK 7 E 05 B 35/04, 37/20 year 1999). This method allows reducing significantly the possibility that these signals appear. They appear when code lock pins move while interacting with locking rod. The above-mentioned method is based on preventive blocking of code lock pins until they contact directly with locking rod. A great disadvantage of the well-known invention lies in the possibility that the signals will appear and be used for unauthorized unblocking of the code unit. These signals are sure to appear when locking rod stops contact with code lock pins that move till they are preventively blocked.

The invention that I propose is aimed at eliminating the possibility of unauthorized code unit unblocking of locking type device by using signals that appear when code lock pins interact with locking rod. This goal is achieved though the method that prevents not only interaction of locking rod with code lock pins or any other interim elements between code lock pins and locking rod but also the possibility to hear the above-mentioned signals. This method allows two-stage blocking: at the first stage locking rod movements are blocked but there is free access to code lock pins or interim elements between code lock pins and locking rod. At the second stage the access to code lock pins or interim elements between code lock pins and locking rod is blocked but locking rod is unblocked and can move within the existing backlash between code lock pins or interim elements between code lock pins and locking rod.

Images 1 and 2 show contact schemes as well as execution order of code unit blocking and unblocking to implement one of the two above-mentioned variants.

Image 1 shows code unit contact scheme when the locking device is blocked. At the same time locking rod 1 is not blocked by blocker 2 and can freely move within the existing backlash, but latch 5 denies access to holes 4 in which code lock pins 13 are placed. This method eliminates the possibility of moving lock pins so that they contact locking rod and thus eliminates the possibility to produce and hear the signals that are used for unauthorized detection of working hollows on lock pins.

Image 2 shows the opposite position of the code unit. The code unit is changed to this position in the following way: controlling device (not shown in the image) moves latch 5 (in this image to the latch moves to the right side) thus allowing access to holes 4 and at the same time sets blocker 2 (using inclined plane 6 and overcoming spring 3) on plane 7 of latch 5. As a result blocker 2 gets in ring groove 10 of locking rod 1 thus blocking its movements even within the existing backlash between code lock pins 13 and locking rod 1 that is bigger than the backlash of blocker 2 in ring groove 10 of locking rod 1. This eliminates the possibility that the signals will appear and be used for unauthorized code unit unblocking of locking type device.

To execute operations necessary for code unit blocking or unblocking one should use key 11 closed with latch 5. At the same time code spikes 12 of key 11 are placed in holes 4. Contact schemes shown in images 1 and 2 correspond to the code unit in CLOSED position. In this position locking rod 1 is dislodged to the left and blocker 2 can get into ring groove 10 thus allowing latch 5 to move to the right affording an opportunity to remove key 11. When the code unit is in OPEN position, a second ring groove 10 (left one in the image) is provided. However, in code units that are used to block locking devices of safes a second ring groove (left one in the image) is not provided in order to make it impossible to remove the key when the code unit is in OPEN position. To realize this method one may use different modifications depending on constructions of code units and locking devices. These modifications are subjects of future engineer developments. For example image 3 shows that locking rod 1 can be blocked by blocker 2 that is put into action by solenoid 9 connected to a button that functions only when latch 5 is in certain specified position.

This invention relates to locking devices and is intended to prevent unauthorized code unit unblocking of locking type device through different manipulations.

It's common knowledge that code units of locking type device use dials to increase the amount of possible combinations. For example dials are used in security locks (patents RU 2083786 year 1997 and RU 2002928). All modifications of dials have discrete marking with different symbols (digits, letters etc) in order to facilitate setting of a dial to working position.

A great disadvantage of this method is the possibility to detect visually working position of a dial and that reduces code unit decipherability of locking type device.

The method that I propose provides for elimination of the possibility to detect visually working position of a dial and that complicates unauthorized code unit unblocking of locking type device.

This goal is achieved through discrete dial marking without any symbols (digits, letters etc). Setting of the dial to working position is realized through counting out discrete marking points while turning the dial after a signal that appears in a certain moment provided by the construction of the dial and that can be perceived only by tactile organs (fingers of the hand). To get such kind of a signal there is a special device on the dial case hidden from observation. This device calls a signal when the dial is turned to an unforeseen angle. That signal is perceived only by tactile organs (fingers of the hand) and is a reference point for counting out marking points to set the dial to working position.

There can be different engineering solutions to get such a signal that is perceived only by tactile organs. These solutions depend on code unit construction and are subjects of future engineer developments.

Image 4 shows construction solution scheme containing dial 14 with discrete marking on its visible part 15. The discrete marking has no symbols and no fixation of marking points. Hidden part 16 of dial 14 has hollow 17 and cylinder body 18 with rounded head 19 interacting with spring 20 Cylinder body 18 is placed in the case canal (not shown in the image). On the visible part of the case there is also arrow 21.

The operation procedure is as follows: when turning the dial to an unforeseen angle, hollow 17 contacts with rounded head 19 of cylinder body 18 thus calling a signal perceived by fingers of the hand. This signal is a reference point for counting out certain amount of marking points from arrow 21 to set dial 14 to the point that corresponds to its working position.

Image 5 shows construction solution scheme containing dial 14 on its visible part 15. Dial 14 has discrete marking without any symbols. Hidden part 16 has hollows 17 around dial circle that fix positions of marking points (one hollow 22 is of bigger diameter than other hollows) and small ball 23 interacting with spring 20. Small ball 23 is placed in the case canal (not shown in the image). On the visible part of the case there is also arrow 21.

The setting of dial 14 to working position is done in the following way: when turning the dial to an unforeseen angle, hollow 22 contacts with small ball 23 thus calling a signal that is easily perceived by fingers of the hand and that differs from other signals appearing when small ball 23 contacts other hollows 17. This very signal is a reference point for counting out certain amount of marking points from arrow 21 to set dial 14 to the point that corresponds to its working position.

In other constructions hollows that call signals can be placed on the end face of the dial that is not seen.

The application of the suggested method in locking type devices that have dials (especially in safes) will make these devices resistant to unauthorized unblocking through different manipulations.

### SUBJECT OF INVENTION

1. This method of preventing unauthorized code unit unblocking of locking type device that contains code lock pins interacting with locking rod or interim elements between code lock pins and locking rod is remarkable for its ability to eliminate the signals used for unauthorized code unit unblocking and at the same time to allow two-stage blocking: either by blocking of locking rod with free access to code lock pins or interim elements between code lock pins and locking rod, or by denying access to code lock pins or interim elements between code lock pins and locking rod when locking rod is unblocked.

2. The method of code unit unblocking of locking type device that contains a revolving dial with discrete marking without any symbols to set it to working position is characterized by the fact that setting of the dial to working position is done through counting out marking points from the signal that appears when the dial is turned and that is perceived only by tactile organs.

### SUMMARY

The method of unauthorized code units unblocking through certain manipulations aimed at listening to signals that appear when code elements contact with locking rod and that are easily picked by human ear is widely used in practice.

The suggested method allows eliminating the possibility of unauthorized code unit unblocking by using such signals through two-stage blocking: either by blocking of locking rod with free access to code lock pins or interim elements between code lock pins and locking rod, or by denying access to code lock pins or interim elements between code lock pins and locking rod when locking rod is unblocked.

Locking type devices that have dials with discrete marking with symbols (for example digits) are widely used in practice. The symbols are used to set the dial to working position. However, it is possible to see the right combination and then the dial can be illicitly set to working position.

The suggested method allows eliminating such possibility through using discrete marking without any symbols. The dial is set to working position through counting out marking points from the signal that is perceived by tactile organs.

List of tlments

1. Locking rod

2. Blocker

3. Spring

4. Hole

5. Latch

6. Inclined plane

7. Plane

8. Button

9. Solenoid

10. Ring groove of locking rod

11. Key

12. Code spike of the key

13. Dial

14. Visible part of the dial

15. Hidden part of the dial

16. Hollow

17. Cylinder body

18. Rounded head of cylinder bodi

19. Spring

20. Arrow

21. Hollow of a bigger diameter

22. Small ball

1. A method for preventing an unauthorized code unit unblocking of a locking type device that contains code lock pins interacting with a locking rod or interim elements between the code lock pins and the locking rod, which method provides ability to eliminate signals used for the unauthorized code unit unblocking by providing locking rod movements blocked when the code lock pins or interim elements between code lock pins and the locking rod are unblocked, and allowing unblocked locking rod movements having the code lock pins or interim elements between code lock pins and the locking rod blocked.

2. The method according to claim 1, wherein said unblocking and blocking is carried out by a blocker operated by a solenoid interacting with a latch while blocking and unblocking the locking rod.

3. A method for preventing an unauthorized code unit unblocking of a locking type device that contains at least one revolving dial with discrete dial marks without any symbols, wherein setting the dial to a working position is carried out by counting a predetermined number of the dial marks from a fixed mark after a signal which appears while turning the dial and which is perceived by tactile organs only.

4. The method according to claim 3, wherein counting the predetermined number of discrete marks is carried out after occurrence of a signal that differs from any other signals arising while turning the dial.
